(19) United States
(12) Patent Application Publication
(10) Pub. No.: US 2021/0139046 A1
(43) Pub. Date: May 13, 2021

(54) METHOD FOR OPERATING A MORE HIGHLY AUTOMATED VEHICLE (HAV), IN PARTICULAR A HIGHLY AUTOMATED VEHICLE

(71) Applicant: Robert Bosch GmbH, Stuttgart (DE)

(72) Inventors: Ali Alawieh, Abstatt (DE); Carsten Hasberg, Ilsfeld-Auenstein (DE); Danny Hiendriana, Ludwigsburg (DE); Fabian Dominik Reister, Bad Liebenzell (DE); Jan-Hendrik Pauls, Grossbottwar (DE); Muhammad Sheraz Khan, Heilbronn (DE); Philipp Rasp, Wannweil (DE); Valentin Frommherz, Heilbronn (DE)

(21) Appl. No.: 16/628,402

(22) PCT Filed: Jun. 4, 2018
(86) PCT No.: PCT/EP2018/064619

§ 371 Date: Jan. 3, 2020

(30) Foreign Application Priority Data
Jul. 7, 2017 (DE) 10 2017 211 629.3

(51) Int. Cl. B60W 60/00; G01C 21/00; G01C 21/34; G01S 19/42; G01C 22/00

(52) U.S. Cl. CPC B60W 60/001; G01C 21/3889; G01C 21/3453; G01S 19/42; G01C 21/3837; B60W 60/0053; B60W 2520/105; B60W 2556/65; B60W 2556/50; B60W 2420/42; B60W 2520/28; B60W 2510/20; G01C 22/00

(57) ABSTRACT

A method for locating a highly automated vehicle (HAV) in a digital location map, including: providing a digital map in a driver assistance system of the HAV; determining a current vehicle position, and locating the vehicle position in the digital map; identifying a route segment currently traveled by the HAV in the digital map; providing at least one traveled comparison trajectory of at least one additional vehicle along the currently traveled route segment; comparison of the at least one comparison trajectory with the currently traveled route segment as indicated in the digital map, and ascertaining a difference value as a result of the comparison; and ascertaining an up-to-dateness of the currently traveled route segment in the digital map, at least partly on the basis of the difference value.

### FIELD

The present invention relates to a method for operating a more highly automated vehicle (HAV), in particular a highly automated vehicle, and to a driver assistance system for controlling a more highly automated vehicle (HAV), in particular a highly automated vehicle.

### BACKGROUND INFORMATION

As the degree of automation of vehicles increases, more and more complex driver assistance systems are coming into use. For such driver assistance systems and functions, such as highly automated driving or fully automated driving, a large number of sensors in the vehicle that enable a precise acquisition of the environment surrounding the vehicle are required.

In the following, “more highly automated” is understood as referring to all degrees of automation that correspond to an automated longitudinal and transverse guiding, with increasing system responsibility, e.g., highly automated and fully automated driving, as defined by the Bundesanstalt für Straβenwesen (BASt) (Federal Highway Research Institute).

In the existing art, a large number of possibilities are described for carrying out a method for operating a highly automated vehicle (HAV). In order to increase the accuracy of location of the highly automated vehicle (HAV) in a digital map, it is necessary to be able to guarantee the accuracy of the digital map at all times.

However, in this context it is problematic that relevant information stored in the digital map, such as indications of overall roadway design and/or for example the position of guardrails, bridges, roadway markings and/or traffic signs, can change in a very short time in real-world conditions. If there are significant differences between the environmental model and the digital map, it is to be assumed that the map contains errors, and thus can continue to be used only to a limited extent, in order to satisfy the requirement of traffic safety.

In order to control the vehicle with a higher degree of automation in as many situations as possible, it is therefore necessary to have access to a digital map that is as free from error as possible and that corresponds to reality as closely as possible.

It is conventional that on the basis of various environmental sensors, such as radar sensors, cameras, driving dynamics sensors, GPS (Global Positioning System), and digital maps, a representation of the environment surrounding the vehicle, the so-called environmental model, can be constructed, and the up-to-dateness of a digital map can be validated, and increased if necessary, through a comparison of the sensor data, or of the environmental model, with the digital map. If the environmental model and the digital map have significant deviations, it is to be assumed that the map is not up-to-date, and can continue to be used only to a limited extent.

Here the problem arises that the resolution of currently used sensors at a distance is, generally, low, and the data therefore have a more or less strong noise portion that makes a reliable evaluation more difficult or even impossible. In the existing art, algorithms for determining position on the basis of data from environmental sensors therefore primarily concentrate on the near field, which can be acquired with a high degree of reliability.

However, in particular when driving at high speed this presents a safety hazard, because a timely reaction to the often small changes in the route is possible only if environmental features that are sufficiently far away can be used to validate the map. Certain calculations based on the sensor data can also be carried out with a higher degree of precision when the features used as reference are as far away as possible; for example, inferences of the angle of rotation of the sensor system used relative to the orientation of the digital map.

### SUMMARY

It is an object of the present invention to provide an improved method for operating a more highly automated vehicle (HAV), in particular a highly automated vehicle, and an improved driver assistance system for controlling a more highly automated vehicle (HAV), in particular a highly automated vehicle, with which reliable information about the quality of sensor detections even in the far range is possible, and with which, ultimately, changes in the route relative to the route status stored in a digital map (also referred to as map errors for short) can be recognized early and in robust fashion, thus providing an improved validation of a digital map.

The object may be achieved by an example embodiment of the present invention. Advantageous embodiments of the present invention are described herein.

According to an aspect of the present invention, an example method is provided for operating a more highly automated vehicle (HAV), in particular a highly automated vehicle, including the following steps:
S1 providing a digital map, preferably a highly accurate digital map, in a driver assistance system of the HAV;
S2 determining a current vehicle position, and locating the vehicle position in the digital map;
S3 identifying a route segment currently traveled by the HAV in the digital map, the identification taking place at least in part on the basis of the current vehicle position and/or on the basis of a current change in the current vehicle position;
S4 providing at least one traveled comparison trajectory of at least one additional vehicle along the currently traveled route segment, the additional vehicle having already traveled the currently traveled route segment, and/or the additional vehicle being situated in front of the HAV on the currently traveled route segment;
S5 comparison of the at least one comparison trajectory with the currently traveled route segment as indicated in the digital map, and ascertaining a difference value as a result of the comparison; and
S6 ascertaining an up-to-dateness of the currently traveled route segment in the digital map, at least partly on the basis of the difference value.

According to a specific embodiment of the present invention, it is provided that in the case in which the difference value exceeds a defined threshold value of a deviation, a request is made to a driver of the HAV to take over driving responsibilities, and/or a request is made to a central map server to provide an update of the digital map.

According to a further specific embodiment of the present invention, it is provided that an item of information relating to the size of the difference value and/or the route course is communicated to the central map server, the central map server communicating this information to other highly automated vehicles, and this communication preferably taking place in the form of an update of the digital map.

Preferably, step S4 includes that the at least one traveled comparison trajectory is ascertained using a GPS system integrated in the at least one additional vehicle, and/or that the at least one traveled comparison trajectory is ascertained using at least one suitable sensor integrated into the at least one additional vehicle, in the context of an odometry calculation.

Preferably, in step S4 a plurality of comparison trajectories of a plurality of additional vehicles are communicated to the HAV, and in step S5 are compared to the currently traveled route segment as indicated in the digital map, the ascertaining of the difference value taking place using a statistical evaluation of these comparisons.

Here it is advantageous that the at least one comparison trajectory is communicated from the at least one additional vehicle to the HAV, using a vehicle-to-vehicle system (V2V), and/or that the at least one comparison trajectory is communicated to a central server computer, the central server computer in particular being a vehicle-to-infrastructure system (V2I) or a cloud system.

In a further specific embodiment of the present invention, information from environmental sensors of the HAV is used to plausibilize the current vehicle position, in the case that the difference value exceeds a defined threshold value of a deviation.

A further subject matter of the present invention is an example driver assistance system for controlling a more highly automated vehicle (HAV), in particular a highly automated vehicle. Here, the driver assistance system includes at least one memory module for storing a digital map, preferably a highly accurate digital map, the memory module in particular being a memory module integrated in the HAV or a central server. In addition, the driver assistance system has a position module for determining a position of the HAV, an interface for exchanging data with a remote data source, in particular a vehicle-to-vehicle system or a vehicle-to-infrastructure system, and a control device. The position module is preferably a GPS module. In addition, the control device is set up to exchange data with the memory module, the position module, and the interface, and to locate the vehicle position, determined by the position module, in the digital map. In addition, the control device is set up to identify a route segment currently being traveled by the HAV in the digital map, the identification being done at least in part on the basis of the current vehicle position and/or on the basis of a current change in the current vehicle position. According to the present invention, it is provided that the interface is set up to receive at least one traveled comparison trajectory of at least one additional vehicle along the currently traveled route segment. The control device is set up to carry out a comparison of the at least one comparison trajectory with the currently traveled route segment as indicated in the digital map, using the comparison trajectory, and to ascertain a difference value as the result of the comparison.

Advantageously, the control device is set up to ascertain a comparison trajectory of a route segment traveled by the HAV, and to provide it to other vehicles via the interface.

In addition, in a further specific embodiment the control device in accordance with the present invention is set up to ascertain the at least one traveled comparison trajectory using data received via the position module, and/or is set up to ascertain the at least one traveled comparison trajectory using sensor data of at least one suitable sensor in the context of an odometry calculation.

Preferably, the at least one suitable sensor is selected from the group of the following sensors: acceleration sensors, rotational rate sensors, camera sensors, wheel rotational speed sensors, steering angle sensors; and the control device is set up to carry out the odometry calculation using at least one of the following methods: Inertial Navigation System (INS), visual odometry, vehicle odometry.

A further subject matter of the present invention is an example computer program that includes program code for carrying out the method according to the present invention when the computer program is executed on a computer.

Although in the following the present invention is described mainly in connection with passenger vehicles, it is not limited thereto, but rather can be used with any type of vehicle, trucks and/or passenger vehicles.

Further features, possible applications, and advantages of the present invention result from the following description of the exemplary embodiments of the present invention shown in the Figures. It is to be noted that the depicted features have a merely descriptive character, and may also be used in combination with features of other further developments described above, and are not intended to limit the present invention in any way.

### BRIEF DESCRIPTION OF THE DRAWINGS

In the following, the present invention is explained in more detail on the basis of a preferred exemplary embodiment, and identical reference characters are used for identical features. The figures are schematic.

FIG. 1 shows a flow diagram of a first specific embodiment of the method according to the present invention.

FIG. 2 shows a schematic representation of the realization of a second specific embodiment of the method according to the present invention.

FIG. 3 shows a flow diagram of a third specific embodiment of the method according to the present invention.

### DETAILED DESCRIPTION OF EXAMPLE EMBODIMENTS

In step S1 of FIG. 1, a digital map, preferably a highly accurate digital map, is provided, which can take place at the device in a memory module for storing the digital map, the memory module in particular being a memory module integrated in the HAV or being a central server.

Step S2 includes the determination of a current vehicle position and location of the vehicle position in the digital map, as is conventional in the existing art. At the device, according to the present invention this takes place using a position module, the position module preferably being a GPS (Global Positioning System) module.

The step designated S3 in FIG. 1 includes the identification of a route segment currently being traveled by the HAV in the digital map, the identification taking place at least partly on the basis of the current vehicle position and/or on the basis of a current change in the current vehicle position.

In the example of FIG. 2, this currently traveled route segment includes two lanes 101, 102, to which two target trajectories 110, 111 are assigned. This information is stored in the current state of the digital map, and is read out by a control device from a memory module in which the digital map is stored.

In the example of FIG. 2, the actual course of the route has changed relative to the states stored in the map. This is identified by actual trajectories 110′, 111′. The deviations between target trajectories 110, 111 and actual trajectories 110′, 111′ may be caused for example by a temporary construction site.

In the existing art, this deviation can cause problems with regard to traffic safety, because a driver assistance system of a more highly automated vehicle may not timely recognize the deviation. According to the present invention, in step S4 of FIG. 1 the provision of at least one traveled comparison trajectory of at least one additional vehicle along the currently traveled route segment is provided, the additional vehicle already having traveled the currently traveled route segment, and/or the additional vehicle being situated on the currently traveled route segment in front of the HAV. In this way, the actual trajectories 110′, 111′ are known to the driver assistance system of the HAV. Through step S5 of comparison of the at least one comparison trajectory with the currently traveled route segment, as indicated in the digital map, a difference value can now be ascertained as the result of the comparison.

In step S6, the up-to-dateness of the currently traveled route segment in the digital map is ascertained, at least partly on the basis of the difference value. In this way, in the example of FIG. 2 the deviation of actual trajectories 110′, 111′ from the previously assumed target trajectories 110, 111 is provided to the driver assistance system.

If the difference value exceeds a defined threshold value of a deviation, than according to a specific embodiment of the present invention a request is made to a driver of the HAV to take over driving responsibility, and/or a request is made to a central map server to provide an update of the digital map. In the example of FIG. 2, given the massive deviation of actual trajectories 110′, 111′ from target trajectories 110, 111, it is to be assumed that the defined threshold value of the deviation has been exceeded. The digital map stored in the memory module of the driver assistance system is clearly no longer up-to-date.

The example of FIG. 2 has to do with a route segment having two lanes 101, 102. In order to make it possible to obtain the information that the two lanes 101, 102 are affected by the temporary change in the route course, in step S4 a plurality of comparison trajectories of a plurality of additional vehicles are thus communicated to the HAV, and in step S5 they are compared to the currently traveled route segment as indicated in the digital map, the ascertaining of the difference value taking place using a statistical evaluation of these comparisons. In this way, individual lane changes of individual vehicles, for example from lane 101 to lane 102, can be recognized as such and can be filtered out in the ascertaining of the actual trajectories 110′, 111′.

FIG. 3 shows a further example of a traffic situation in which the method according to the present invention can be used to increase traffic safety. In this case, the route segment to be traveled has lanes 101, 102, 103, each having associated target trajectories 110, 111, 112. In FIG. 3, it can be seen that, due to a temporary change of route, the current route segment cannot be traveled as stored in the digital map, because a part of lane 101 is closed to traffic. An actual trajectory 110′ running along lane 101 therefore has a deviation from target trajectory 110, and moves into target trajectory 111. The target trajectories running along lanes 102, 103 are not affected by the change in traffic.

The method according to the present invention also acquires this situation through the accumulation of target trajectories 110′, 111′, 112′ of a large number of vehicles and their statistical evaluation, as already explained in connection with FIG. 2. A specific embodiment of the present invention provides that the statistical evaluation includes a classifier, for example a neural network, with which the type of traffic change is acquired, for example construction site entrances, displacement of some or of all lanes, and/or accidents.

The present invention is not limited to the exemplary embodiment described and depicted. Rather, it also includes all developments within the competence of those skilled in the art, within the scope of the present invention.

In addition to the described and depicted specific embodiments, further specific embodiments are possible that may include further modifications and combinations of features.

1-12 (canceled)

13. A method for operating a highly automated vehicle (HAV), comprising the following steps:
S1) providing a digital map in a driver assistance system of the HAV;
S2) determining a current vehicle position, and locating a position of the HAV in the digital map;
S3) identifying a route segment currently traveled by the HAV in the digital map, the identification taking place at least in part based on the current vehicle position and/or based on a current change in the current vehicle position;
S4) providing at least one traveled comparison trajectory of at least one additional vehicle along the currently traveled route segment, the additional vehicle having already traveled the currently traveled route segment, and/or the additional vehicle being situated in front of the HAV on the currently traveled route segment;
S5) comparing the at least one comparison trajectory with the currently traveled route segment as indicated in the digital map, and ascertaining a difference value as a result of the comparison; and
S6) ascertaining an up-to-dateness of the currently traveled route segment in the digital map, at least partly based on the difference value.

14. The method as recited in claim 13, wherein the digital map is a highly accurate digital map.

15. The method as recited in claim 13, wherein when the difference value exceeds a defined threshold value of a deviation: (i) a request is made to a driver of the HAV to take over driving responsibility, and/or (ii) a request is made to a central map server to provide an update of the digital map.

16. The method as recited in claim 15, wherein an item of information relating to the size of the difference value and/or to the route segment is communicated to the central map server, the central map server communicating the item of information to additional highly automated vehicles, and the communication taking place in the form of an update of the digital map.

17. The method as recited in claim 13, wherein the step S4 includes ascertaining the at least one traveled comparison trajectory using a GPS system integrated in the at least one additional vehicle, and/or the at least one traveled comparison trajectory is ascertained using at least one sensor integrated in the at least one additional vehicle, in the context of an odometry calculation.

18. The method as recited in claim 13, wherein in the step S4 a plurality of comparison trajectories of a plurality of additional vehicles are communicated to the HAV, and in the step S5 the plurality of comparison trajectories are compared with the currently traveled route segment as indicated in the digital map, the ascertaining of the difference value taking place using a statistical evaluation of the comparisons.

19. The method as recited in claim 13, wherein: (i) the at least one comparison trajectory is communicated from the at least one additional vehicle to the HAV by a vehicle-to-vehicle system (V2V), and/or (ii) the at least one comparison trajectory is communicated to a central server computer, the central server computer being in a vehicle-to-infrastructure system (V2I) or a cloud system.

20. The method as recited in claim 13, wherein when the difference value exceeds a defined threshold value of a deviation, information from environmental sensors of the HAV is used to plausibilize the current vehicle position.

21. A driver assistance system for controlling a highly automated vehicle (HAV), comprising:
a memory module storing a digital map, the memory module being a memory module integrated in the HAV or being a central server;
a position module configured to determine a vehicle position of the HAV;
an interface configured to exchange data with a remote data source; and
a control device configured to exchange data with the memory module, the position module, and the interface, and to locate the vehicle position determined by the position module in the digital map, and configured to identify a route segment currently traveled by the HAV in the digital map, the identification taking place at least partly based on the current vehicle position and/or at least partly based on a current change of the current vehicle position;
wherein the interface is configured to receive at least one traveled comparison trajectory of at least one additional vehicle along the currently traveled route segment, the control device being configured to carry out, using the comparison trajectory, a comparison of the at least one comparison trajectory with the currently traveled route segment as indicated in the digital map, and to ascertain a difference value as a result of the comparison.

22. The driver assistance system as recited in claim 21, wherein the digital map is a highly accurate digital map.

23. The driver assistance system as recited in claim 21, wherein the position module is a GPS module.

24. The driver assistance system as recited in claim 21, wherein the remote data source is in a vehicle-to-vehicle system or in a vehicle-to-infrastructure system.

25. The driver assistance system as recited in claim 21, wherein the control device is configured to ascertain a comparison trajectory of a route segment traveled by the HAV and to provide it to other vehicles via the interface.

26. The driver assistance system as recited in claim 25, wherein the control device is configured to ascertain the at least one traveled comparison trajectory using the data received via the position module, and/or is configured to ascertain the at least one traveled comparison trajectory using sensor data of at least one sensor, in the context of an odometry calculation.

27. The driver assistance system as recited in claim 26, wherein the at least one sensor is selected from the group of the following sensors: acceleration sensors, rotational rate sensors, camera sensors, wheel rotational speed sensors, steering angle sensors; and the control device is configured to carry out the odometry calculation at least using one of the following methods: Inertial Navigation System (INS), visual odometry, vehicle odometry.

28. A non-transitory computer-readable storage medium on which is stored a computer program including program code for operating a highly automated vehicle (HAV), the computer program, when executed by a computer, causing the computer to perform the following steps:
S1) providing a digital map in a driver assistance system of the HAV;
S2) determining a current vehicle position, and locating a position of the HAV in the digital map;
S3) identifying a route segment currently traveled by the HAV in the digital map, the identification taking place at least in part based on the current vehicle position and/or based on a current change in the current vehicle position;
S4) providing at least one traveled comparison trajectory of at least one additional vehicle along the currently traveled route segment, the additional vehicle having already traveled the currently traveled route segment, and/or the additional vehicle being situated in front of the HAV on the currently traveled route segment;
S5) comparing the at least one comparison trajectory with the currently traveled route segment as indicated in the digital map, and ascertaining a difference value as a result of the comparison; and
S6) ascertaining an up-to-dateness of the currently traveled route segment in the digital map, at least partly based on the difference value.
